(19) United States
(12) Patent Application Publication
(10) Pub. No.: US 2015/0222649 A1
(43) Pub. Date: Aug. 6, 2015

(54) METHOD AND APPARATUS FOR PROCESSING A WEBPAGE

(71) Applicants: Fansheng ZENG, Shenzhen (CN); Bin GAO, Shenzhen (CN)

(72) Inventors: Fansheng ZENG, Shenzhen (CN); Bin GAO, Shenzhen (CN)

(21) Appl. No.: 14/688,924

(22) Filed: Apr. 16, 2015

Related U.S. Application Data
(63) Continuation of application No. PCT/CN2013/084317, filed on Sep. 26, 2013.

(30) Foreign Application Priority Data
Oct. 17, 2012 (CN) 201210393872.X

(51) Int. Cl. H04L 29/06; H04L 29/08; G06F 17/30

(52) U.S. Cl. CPC H04L 63/1416; G06F 17/30864; H04L 67/02

(57) ABSTRACT

The present disclosure describes a method for processing a webpage. A user device obtains a gesture track of a user and queries a gesture track database according to the gesture track obtained, wherein the gesture track database stores a relationship between the gesture track and account information of the user. The user device obtains the account information corresponding to the gesture track and provides the account information to a log-in server, so as to log in the application.

### CROSS-REFERENCE TO RELATED APPLICATIONS

This application is a continuation of International Application No. PCT/CN2013/084317, filed on Sep. 26, 2013. This application claims the benefit and priority of Chinese Patent Application No. 201210393872.X, filed Oct. 17, 2012. The entire disclosures of each of the above applications are incorporated herein by reference.

### FIELD

The present disclosure relates to Internet techniques, and more particularly, to a method and an apparatus for processing a webpage.

### BACKGROUND

With the popularization of the Internet, users use the Internet more and more frequently. Therefore, it is required to ensure the security of users' computers on the Internet.

Each webpage on the Internet has a unique webpage identifier, generally referred to as a Uniform/Universal Resource Locator (URL) address, a web address or a website address. When the user logs in on the Internet, malicious webpage identifiers usually emerge. These malicious webpage identifiers usually force the user to visit some webpages through modifying a browser homepage of the user's computer, or adding a desktop shortcut, or forbidding restoring to factory configurations or deleting them. These malicious webpage identifiers generally direct to advertisement websites, virus websites or some other undesirable websites, which affects normal browsing of the user and threatens the security of the user's computer.

### SUMMARY

According to an example of the present disclosure, a method for processing a webpage is provided. The method includes:

obtaining, by a user device, a webpage identifier;

determining, by the user device, whether the webpage identifier is in a predefined standard format; if the webpage identifier is not in the predefined standard format, converting, by the user device, the webpage identifier into a webpage identifier in the predefined standard format; and

generating, by the user device, a querying request and transmitting the querying request to a cloud server to receive a querying result; wherein the querying request comprises the webpage identifier in the standard format, the querying result comprises information indicating whether the webpage identifier is malicious.

According to another example of the present disclosure, a method for processing a webpage is provided. The method includes:

receiving, by a cloud server, a querying request transmitted by a user device, wherein the querying request comprises a webpage identifier;

determining, by the cloud server, whether the webpage identifier in the querying request is malicious; and

generating, by the cloud server, a querying result and transmitting the querying result to the user device, wherein the querying result comprises information indicating whether the webpage identifier is malicious.

According to still another example of the present disclosure, a user device for processing a webpage is provided. The cloud server includes:

one or more processors;

memory; and

one or more program modules stored in the memory and to be executed by the one or more processors, the one or more program modules comprise:

a webpage identifier obtaining module, to obtain a webpage identifier;

a format determining module, to determine whether the webpage identifier obtained by the webpage identifier obtaining module is in a predefined standard format;

a format converting module, to convert the webpage identifier into a webpage identifier in the standard format if the format determining module determines that the webpage identifier is not in the standard format; and

a querying module, to generate a querying request and transmit the querying request to a cloud server to obtain a querying result; wherein the querying request comprises the webpage identifier; the querying result comprises information indicating whether the webpage identifier is malicious.

Other aspects or embodiments of the present disclosure can be understood by those skilled in the art in light of the description, the claims, and the drawings of the present disclosure.

### BRIEF DESCRIPTION OF THE DRAWINGS

Features of the present disclosure are illustrated by way of example and not limited in the following figures, in which like numerals indicate like elements, in which:

FIG. 1 is a schematic diagram illustrating an example of a user device and a cloud server for executing the method of the present disclosure.

FIG. 2 is a flowchart illustrating a method for processing a webpage at a user device side according to an example of the present disclosure.

FIG. 3 is a flowchart illustrating a method for processing a webpage at a user device side according to another example of the present disclosure.

FIG. 4 is a flowchart illustrating a method for processing a webpage at a user device side according to still another example of the present disclosure.

FIG. 5 is a flowchart illustrating a method for processing a webpage at a cloud server side according to an example of the present disclosure.

FIG. 6 is a schematic diagram illustrating a structure of a user device according to an example of the present disclosure.

FIG. 7 is a schematic diagram illustrating a structure of a user device according to another example of the present disclosure.

FIG. 8 is a schematic diagram illustrating a structure of a user device according to still another example of the present disclosure.

FIG. 9 is a schematic diagram illustrating a structure of a user device according to yet another example of the present disclosure.

FIG. 10 is a schematic diagram illustrating a cloud server according to an example of the present disclosure.

### DETAILED DESCRIPTION

The preset disclosure will be described in further detail hereinafter with reference to accompanying drawings and examples to make the technical solution and merits therein clearer.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

Conventional systems can find and deal with malicious program such as troy horse and virus through real-time protection and file scanning. The malicious program usually directs to advertisement websites, virus websites or other undesirable websites. Although the malicious program can be removed, the malicious webpage identifiers of the malicious websites are not removed. It is difficult for the security software to recognize whether the malicious webpage identifiers are configured by the user or by the malicious program. And the user will still visit the websites directed by the malicious webpage identifiers. The reason is that conventional security software lacks the ability of recognizing and processing the malicious webpage identifiers. In addition, the real-time protection function also cannot effectively recognize webpage addresses not in standard formats. Thus, the malicious webpage identifiers in the computer cannot be removed thoroughly.

In various examples of the present disclosure, a webpage identifier is obtained. It is determined whether the webpage identifier is in a predefined standard format. If not, the obtained webpage identifier is converted into the standard format. A querying request is generated and transmitted to a cloud server to obtain a querying result. The querying request includes the webpage identifier in the standard format and the querying result includes information indicating whether the webpage identifier is malicious.

FIG. 1 is a schematic diagram illustrating an example of a user device and a cloud server which may execute the method of the present disclosure. As shown in FIG. 1, a user device 110 and a cloud server 120 may be computing devices capable of executing methods and apparatuses of present disclosure. The user device 110 may, for example, be a device such as a personal desktop computer or a portable device, such as a laptop computer, a tablet computer, a cellular telephone, or a smart phone.

The user device 110 may include one or more non-transitory processor-readable storage media 151 and one or more processors 152 in communication with the non-transitory processor-readable storage media 151. The user device 110 may include or may execute an operating system 121 and an application 122 executable by a processor to implement the methods provided by the present disclosure.

The cloud server 120 in FIG. 1 represents a computer system that is made available to the user device 110. The cloud server 120 may include one or more non-transitory processor-readable storage media 141 and one or more processors 142 in communication with the non-transitory processor-readable storage media 141. The cloud server 120 may include or may execute an operating system 131 and an application 132 executable by a processor to implement the methods provided by the present disclosure.

The non-transitory processor-readable storage media 151 and 141 may be a RAM memory, flash memory, ROM memory, EPROM memory, EEPROM memory, registers, hard disk, a removable disk, a CD-ROM, or any other form of non-transitory storage medium known in the art.

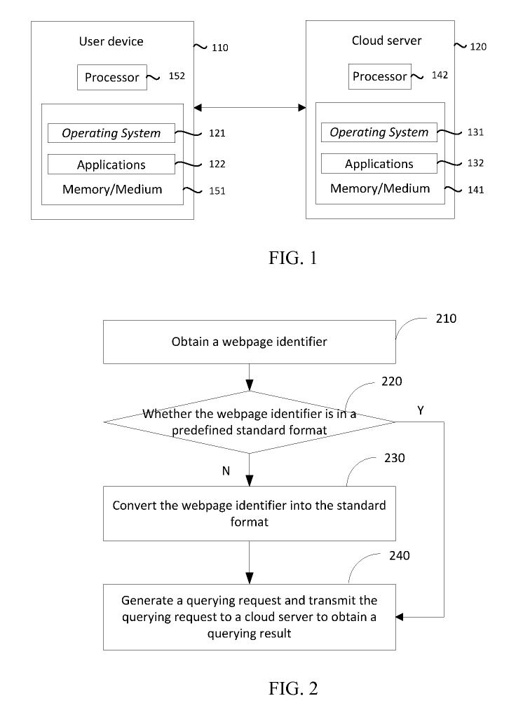

FIG. 2 is a schematic diagram illustrating a method for processing a webpage at a user device side according to an example of the present disclosure. FIG. 2 is a simplified diagram according to one embodiment of the present invention. This diagram is merely an example, which should not unduly limit the scope of the claims. One of ordinary skill in the art would recognize many variations, alternatives, and modifications. As shown in FIG. 2, the method includes the following.

At block 210, a webpage identifier is obtained.

In this example, the webpage identifier may be a URL webpage address or other webpage identifiers, if only a webpage can be obtained according to the webpage identifier.

In a practical application, the webpage identifier may be obtained through any one of the following two manners.

In a first manner, it is determined whether a webpage open instruction is received. If the webpage open instruction is received, the webpage identifier of the webpage being opened is obtained when the webpage is opened. This manner collects the URL address through monitoring a browser, which reduces a collecting area and a collecting difficulty, and improves effectiveness of the collecting of the URL.

In a second manner, a predetermined area of the user device is scanned to obtain the webpage identifier, wherein the predetermined area stores the webpage identifier. In this manner, when the scanning is performed, URL address relevant items are traversed and attributes are allocated to the URLs according to their positions in a system. For example, URLs in a network favorite folder may be omitted, whereas URLs emerged on desktop and start menu should be scanned thoroughly.

In this example, for the URL addresses in the user device, different attributes may be allocated for them according to their positions. In other words, a lenient policy may be adopted for positions familiar to the user, whereas a strict policy may be adopted for positions usually utilized by malicious software.

At block 220, it is determined whether the obtained webpage identifier is in a predefined standard format, if yes, block 240 is performed; otherwise, block 230 is performed.

At block 230, the webpage identifier is converted into a webpage identifier in the standard format.

In particular, a protocol header identifier such as “http://”, “https://” and “www.” is deleted from the URL address. A protocol tail identifier such as “I” is also deleted from the URL address. For example, a URL address “http://www.xxx.com/yyy/” will be converted into the standard format “xxx.com/yyy”. In this example, the obtained webpage identifier is converted into the standard format, which reduce the difficulty for determining whether the webpage identifier is malicious and improves an accuracy ratio of the determination.

At block 240, a querying request is generated and transmitted to the cloud server, so as to obtain a querying result.

The querying request includes the webpage identifier in the standard format. The querying result includes information indicating whether the webpage identifier is malicious.

Through the above blocks 210 to 240, the user device obtains the webpage identifier and converts the webpage identifier into the standard format if the webpage identifier is not in the standard format. The user device transmits the webpage identifier in the standard format to the cloud server which determines whether the webpage identifier is malicious. The method is able to recognize the webpage identifier effectively. The efficiency for removing the malicious webpage identifier in the user device is improved and the security of the user device is protected.

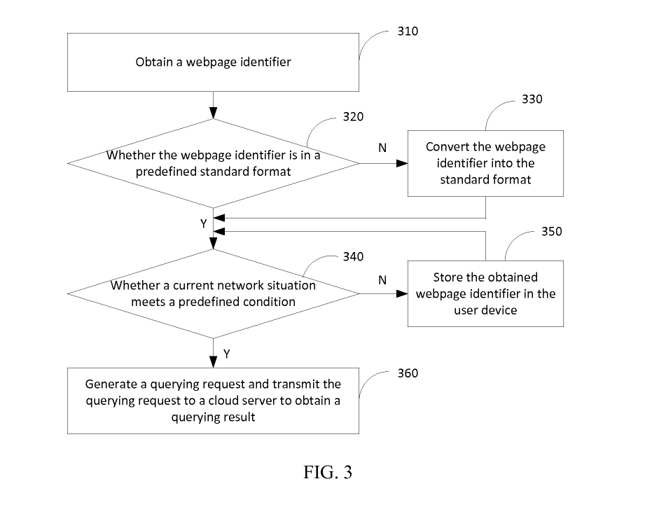

FIG. 3 is a flowchart illustrating a method for processing a webpage according to another example of the present disclosure. In the method as shown in FIG. 3, blocks 310, 320, 330 and 360 are respectively the same with blocks 210 to 240 in FIG. 2. Different from FIG. 2, after block 330, the method as shown in FIG. 3 further includes the following.

At block 340, it is determined whether a current network situation meets a predefined condition for transmitting the querying request to the cloud server, if yes, block 360 is performed; otherwise, block 350 is performed.

In this block, if the network situation is not good or it is unable to connect to the Internet, it is determined that the predefined condition is not met.

At block 350, the obtained webpage identifier is saved in the user device.

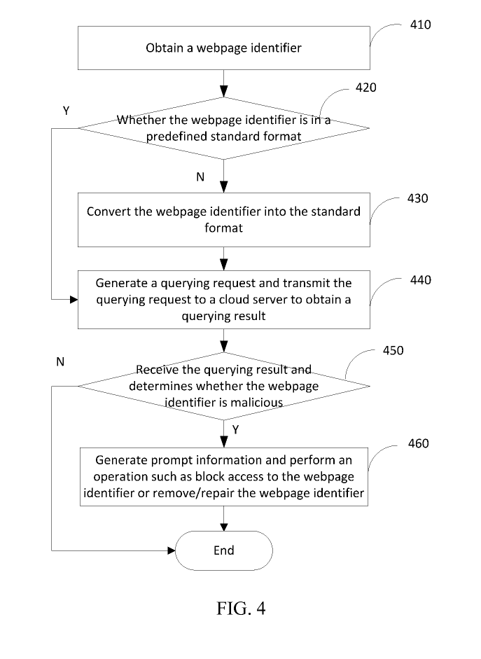

FIG. 4 is a flowchart illustrating a method for processing a webpage according to another example of the present disclosure. In the method as shown in FIG. 4, blocks 410 to 440 are respectively the same with blocks 210 to 240 in FIG. 2. Different from FIG. 2, after block 440, the method as shown in FIG. 4 further includes the following.

At block 450, the querying result is received from the cloud server. It is determined whether the webpage identifier is malicious. If yes, block 460 is performed; otherwise, the method ends.

At block 460, prompt information is generated for the user. Access to the webpage identifier is blocked, or the webpage identifier is removed or repaired.

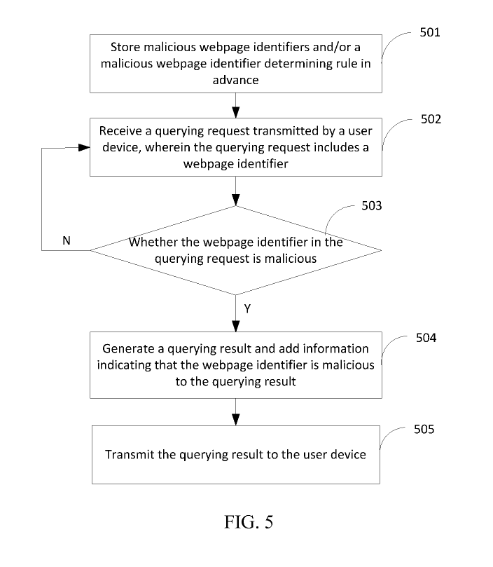

FIG. 5 is a flowchart illustrating a method for processing a webpage at a cloud server side according to an example of the present disclosure. FIG. 5 is a simplified diagram according to one embodiment of the present invention. This diagram is merely an example, which should not unduly limit the scope of the claims. One of ordinary skill in the art would recognize many variations, alternatives, and modifications.

At block 501, malicious webpage identifiers and/or a malicious webpage identifier determining rule are stored in advance.

At block 502, a querying request transmitted by a user device is received, wherein the querying request includes a webpage identifier.

At block 503, it is determined whether the webpage identifier in the querying request is a malicious webpage identifier; if yes, block 504 is performed; otherwise, the method ends.

In this example, there are two manners for determining whether the webpage identifier in the querying request is a malicious webpage identifier.

In a first manner, the webpage identifier in the querying request is compared with malicious webpage identifiers stored in the cloud server. If the webpage identifier in the querying request is the same with one of the malicious webpage identifiers stored in the cloud server, it is determined that the webpage identifier in the querying request is a malicious webpage identifier.

In a second manner, it is determined whether the webpage identifier in the querying request meets the malicious webpage identifier determining rule stored in the cloud server. If the webpage identifier in the querying request meets the malicious webpage identifier determining rule stored in the cloud server, it is determined that the webpage identifier in the querying request is a malicious webpage identifier.

For example, the determining rule may include: whether a querying times of the webpage identifier in the querying request reaches a predefined determining times, if yes, it is determined that the webpage identifier in the querying request is a malicious webpage identifier. In a practical application, the cloud server may sort webpage identifiers according to their querying times. The webpage identifier with a largest querying times ranks in the first. Then, the cloud server may determine that webpage identifiers rank in, e.g. first five are malicious webpage identifiers. In one example, the determination on whether the webpage identifier is malicious may also be performed by a manager.

At block 504, a querying result is generated and information indicating whether the webpage identifier in the querying request is a malicious webpage identifier is added in the querying result.

At block 505, the generated querying result is transmitted to the user device.

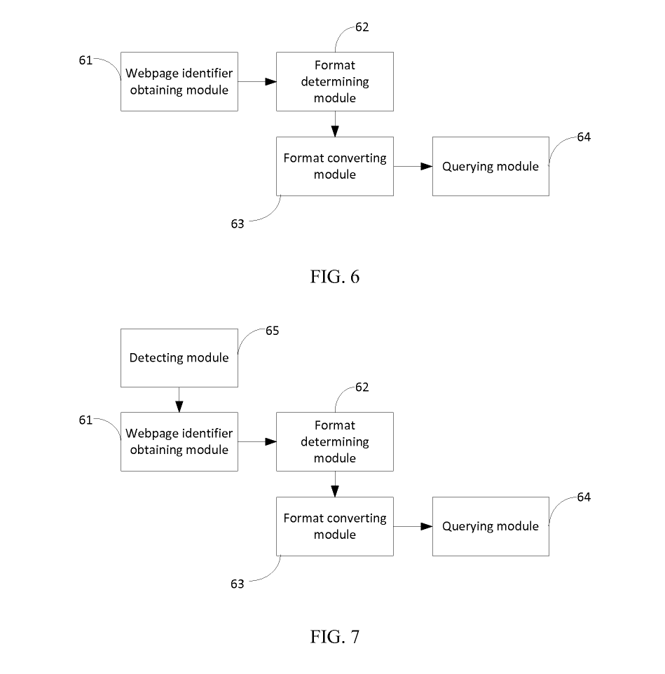

FIG. 6 is a schematic diagram illustrating a user device for processing a webpage according to an example of the present disclosure. As shown in FIG. 6, the user device includes a webpage identifier obtaining module 61, a format determining module 62, a format converting module 63, and a querying module 64.

The webpage identifier obtaining module 61 obtains a webpage identifier of a webpage.

In a practical application, the webpage identifier obtaining module 61 may scan a predetermined area of the user device to obtain the webpage identifier, wherein the predetermined area stores the webpage identifier.

The format determining module 62 determines whether the webpage identifier obtained by the webpage identifier obtaining module 61 is in a predefined standard format. If not, the format converting module 63 converts the webpage identifier into the standard format.

The querying module 64 generates a querying request and transmits the querying request to a cloud server to obtain a querying result. The querying request includes the webpage identifier in the standard format. The querying result includes information indicating whether the webpage identifier is malicious.

FIG. 7 is a schematic diagram illustrating a user device for processing a webpage according to another example of the present disclosure. Compared with the user device as shown in FIG. 6, the user device as shown in FIG. 7 further includes a detecting module 65. The detecting module 65 detects whether a webpage open instruction is received, if the detecting module 65 detects that the webpage open instruction is received, the webpage identifier obtaining module 61 obtains the webpage identifier of the webpage.

Functions and operations of other modules in FIG. 7 are similar to those of corresponding modules as shown in FIG. 6 and will not be repeated herein.

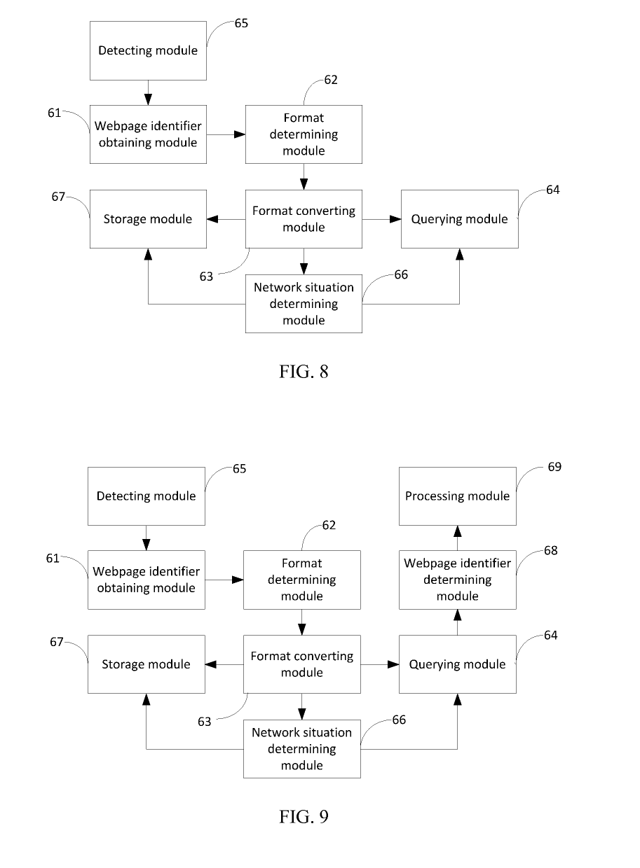

FIG. 8 is a schematic diagram illustrating a user device for processing a webpage according to still another example of the present disclosure. Compared with the user device as shown in FIG. 7, the user device as shown in FIG. 8 further includes a network situation determining module 66 and a storage module 67. The network situation determining module 66 determines whether a current network situation meets a predefined condition for transmitting the querying request to the cloud server. If the network situation determining module 66 determines that the current network situation does not meet the predefined condition, the storage module 67 stores the webpage identifier in the user device. If the network situation determining module 66 determines that the network situation meets the predefined condition, the querying module 64 generates the querying request and transmits the querying request to the cloud server to obtain the querying result.

Functions and operations of other modules in FIG. 8 are similar to those of corresponding modules as shown in FIG. 7 and will not be repeated herein.

FIG. 9 is a schematic diagram illustrating a user device for processing a webpage according to yet another example of the present disclosure. Compared with the user device as shown in FIG. 8, the user device as shown in FIG. 9 further includes a webpage identifier determining module 68 and a processing module 69. The webpage identifier determining module 68 receives the querying result returned by the cloud server and determines whether the webpage identifier is malicious according to the querying result. If the webpage identifier determining module 68 determines that the webpage identifier is malicious, the processing module 69 generates prompt information for the user and processes the webpage identifier, e.g., block access to the webpage identifier or delete the webpage identifier.

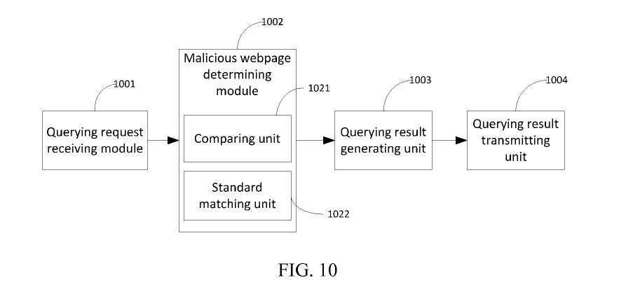

FIG. 10 is a schematic diagram illustrating a structure of a cloud server for processing a webpage according to an example of the present disclosure. FIG. 10 is a simplified diagram according to one embodiment of the present invention. This diagram is merely an example, which should not unduly limit the scope of the claims. One of ordinary skill in the art would recognize many variations, alternatives, and modifications.

As shown in FIG. 10, the cloud server includes: a querying request receiving module 1001, a malicious webpage determining module 1002, a querying result generating module 1003 and a querying result transmitting module 1004.

The querying request receiving module 1001 receives a querying request transmitted by a user device, wherein the querying request includes a webpage identifier. The malicious webpage determining module 1002 determines whether the webpage identifier in the querying request is a malicious webpage identifier.

In a practical application, the malicious webpage determining module 1002 includes a comparing unit 1021 and/or a standard matching unit 1022.

The comparing unit 1021 compares the webpage identifier in the querying request with malicious webpage identifiers stored in the cloud server. If the webpage identifier is the same with one of the malicious webpage identifiers stored in the cloud server, the malicious webpage determining module 1002 determines that the webpage identifier in the querying request is malicious.

The standard matching unit 1022 determines whether the webpage identifier in the querying request meets a malicious webpage identifier determining rule stored in the cloud server. If yes, the malicious webpage determining module 1002 determines that the webpage identifier in the querying request is malicious. The determining rule includes: a querying times of the webpage identifier in the querying request reaches a predefined determining times.

The querying result generating module 1003 generates a querying result and adds information indicating whether the webpage identifier in the querying request is malicious in the querying result. The querying result transmitting module 54 transmits the querying result to the user device.

In examples of the present disclosure, the user device obtains the webpage identifier, converts the webpage identifier into the standard format and transmits the webpage identifier in the standard format to the cloud server which determines whether the webpage identifier is malicious. The solution of the present disclosure effectively identifies the obtained webpage identifier, improves removing efficiency of malicious webpage identifiers in the user device and improves security performance of the user device.

What has been described and illustrated herein is a preferred example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

1. A method for processing a webpage, comprising:
obtaining, by a user device, a webpage identifier;
determining, by the user device, whether the webpage identifier is in a predefined standard format; if the webpage identifier is not in the predefined standard format, converting, by the user device, the webpage identifier into a webpage identifier in the predefined standard format; and
generating, by the user device, a querying request and transmitting the querying request to a cloud server to receive a querying result; wherein the querying request comprises the webpage identifier in the standard format, the querying result comprises information indicating whether the webpage identifier is malicious.

2. The method of claim 1, wherein the obtaining the webpage identifier comprises:
detecting, by the user device, whether a webpage open instruction is received; and
if the webpage open instruction is received, obtaining, by the user device, the webpage identifier of the webpage being opened when the webpage is opened.

3. The method of claim 1, wherein the obtaining the webpage identifier comprises:
scanning, by the user device, a predefined area of the user device to obtain the webpage identifier, wherein the predefined area stores the webpage identifier.

4. The method of claim 1, further comprising:
before generating the querying request and transmitting the querying request to the cloud server, determining, by the user device, whether a current network situation meets a predefined condition for transmitting the querying request to the cloud server;
if the current network situation does not meet the predefined condition, storing the webpage identifier in the user device; and
if the current network situation meets the predefined condition, performing the process of generating the querying request and transmitting the querying request to the cloud server.

5. The method of claim 1, further comprising:
receiving, by the user device, the querying result;
determining, by the user device, whether the webpage identifier is malicious according to the querying result; and
if the webpage identifier is malicious, generating prompt information for a user and processing the webpage identifier.

6. The method of claim 1, wherein the webpage identifier is a webpage address.

7. A method for processing a webpage, comprising:
receiving, by a cloud server, a querying request transmitted by a user device, wherein the querying request comprises a webpage identifier;
determining, by the cloud server, whether the webpage identifier in the querying request is malicious; and
generating, by the cloud server, a querying result and transmitting the querying result to the user device, wherein the querying result comprises information indicating whether the webpage identifier is malicious.

8. The method of claim 7, wherein the determining whether the webpage identifier in the querying request is malicious comprises:
comparing, by the cloud server, the webpage identifier in the querying request with malicious webpage identifiers which are stored in the cloud server in advance, if the webpage identifier in the querying request is the same with one of the malicious webpage identifiers stored in the cloud server, determining, by the cloud server, that the webpage identifier in the querying request is malicious.

9. The method of claim 7, wherein the determining whether the webpage identifier in the querying request is malicious comprises:
determining, by the cloud server, whether the webpage identifier in the querying request meets a malicious webpage identifier determining rule which is stored in the cloud server in advance, if the webpage identifier in the querying request meets the malicious webpage identifier determining rule, determining, by the cloud server, that the webpage identifier in the querying request is malicious.

10. The method of claim 9, wherein the malicious webpage identifier determining rule comprises: a querying times of the webpage identifier in the querying request reaches a predefined determining times.

11. A user device, comprising:
one or more processors;
memory; and
one or more program modules stored in the memory and to be executed by the one or more processors, the one or more program modules comprise:
a webpage identifier obtaining module, to obtain a webpage identifier;
a format determining module, to determine whether the webpage identifier obtained by the webpage identifier obtaining module is in a predefined standard format;
a format converting module, to convert the webpage identifier into a webpage identifier in the standard format if the format determining module determines that the webpage identifier is not in the standard format; and
a querying module, to generate a querying request and transmit the querying request to a cloud server to obtain a querying result; wherein the querying request comprises the webpage identifier; the querying result comprises information indicating whether the webpage identifier is malicious.

12. The user device of claim 11, wherein the one or more program modules further comprise:
a detecting module, to detect whether a webpage open instruction is received; and
the webpage identifier obtaining module is further to obtain, if the detecting module detects that the webpage open instruction is received and when a webpage is opened, the webpage identifier of the webpage being opened.

13. The user device of claim 11, the webpage identifier obtaining module is further to scan a predefined area of the user device to obtain the webpage identifier, wherein the predefined area stores the webpage identifier.

14. The user device of claim 11, wherein the one or more program modules further comprise:
a network situation determining module, to determine whether a current network situation meets a predefined condition for transmitting the querying request to the cloud server;
a storage module, to store the webpage identifier in the user device if the network situation determining module determines that the current network situation does not meet the predefined condition; and
the querying module is further to generate the querying request and transmit the querying request to the cloud server if the network situation determining module determines that the current network situation meets the predefined condition.

15. The user device of claim 11, wherein the one or more program modules further comprise:
a webpage identifier determining module, to receive the querying result and determine whether the webpage identifier is malicious according to the querying result; and
a processing module, to generating prompt information for a user and process the webpage identifier if the webpage identifier determining module determines that the webpage identifier is malicious.
